(19) United States
(12) Patent Application Publication
(10) Pub. No.: US 2014/0289760 A1
(43) Pub. Date: Sep. 25, 2014

(54) MULTIPLE-REGION DISPLAY FOR UNOBTRUSIVE ADVERTISING

(71) Applicant: Saeed Yaghoobzar, Roslyn Heights, NY (US)

(72) Inventor: Saeed Yaghoobzar, Roslyn Heights, NY (US)

(21) Appl. No.: 14/215,760

(22) Filed: Mar. 17, 2014

Related U.S. Application Data
(60) Provisional application No. 61/788,764, filed on Mar. 15, 2013.

(51) Int. Cl. H04N 21/435; H04N 21/81

(52) U.S. Cl. CPC H04N 21/435; H04N 21/812
USPC 725/32

(57) ABSTRACT

A method and system for displaying advertisements in an unobtrusive manner alongside video content. The method comprises displaying primary content on a first region of a display and displaying an advertisement on a second region of the display, wherein the first and second regions of the display are separate screens on the same device.

### FIELD OF THE INVENTION

This invention relates generally to the field of mobile video content. More particularly, this invention relates to a method and mobile device for displaying advertisements in an unobtrusive manner alongside video content.

### BACKGROUND OF THE INVENTION

Many on-line services offer free content. Revenue is generated through selling advertisements that are shown along with the primary content. Websites show advertisements in pop-over or pop-up windows, through interruptions in the content or in other obtrusive manners. Many times users are able to remove the ads by paying a subscription to the service or by purchasing content as desired. The problem with these solutions is that the users become annoyed with the ads interrupting or obscuring the content they are trying to enjoy. This may make the users give up trying to watch and instead find something better to do with their time.

What is needed is a way to continue to show advertisements for revenue generation but in an unobtrusive manner. Besides being more agreeable with a user, many more ads can be shown during the session, because they can be shown continuously without hampering the user's ability to enjoy the content.

### SUMMARY OF THE INVENTION

The present invention relates to a mobile device for displaying advertisements in an unobtrusive manner alongside video content.

In some embodiments of the present invention, there is a physical screen comprising multiple non-overlapping regions wherein the primary content and secondary content are shown in different regions. In some embodiments, the invention comprises more than one physical screen wherein the primary content and the secondary content are shown on different physical screens, which are located adjacent to each other or separated by a small gap. The user is able to see the primary content on a main screen or region while advertisements are displayed on a second screen or region, without the ads blocking or interrupting the main content.

In some embodiments, a second screen is attached to the first screen with a hinge, so that the second screen can be folded onto the first screen when the device is not in use. In some embodiments, there are additional screens also hinged to the main screen.

In some embodiments, ads are related to the video content. The ads are chosen specifically to align with the main content because of a perceived increase in interest for the product or service being sold based on the topic of the primary content or other metrics. When a user chooses to watch certain content, it is presumed that he or she would be interested in a certain group of products or services, and ads targeting this user can be shown on the additional screens.

### BRIEF DESCRIPTION OF THE DRAWINGS

FIG. 1 shows an embodiment of the overall device.

FIG. 2a is a block diagram of an embodiment of the hardware of the device with more than one screen.

FIG. 2b is a block diagram of an embodiment of the hardware of the device with one screen comprising multiple regions.

FIG. 3 is a flow chart describing operation of an embodiment of the invention.

### DETAILED DESCRIPTION OF THE INVENTION

In the following description, reference is made to the accompanying drawings that form a part hereof, and in which is shown by way of illustration of specific embodiments in which the invention may be practiced. It is to be understood that other embodiments may be utilized and structural changes may be made without departing from the scope of the present invention.

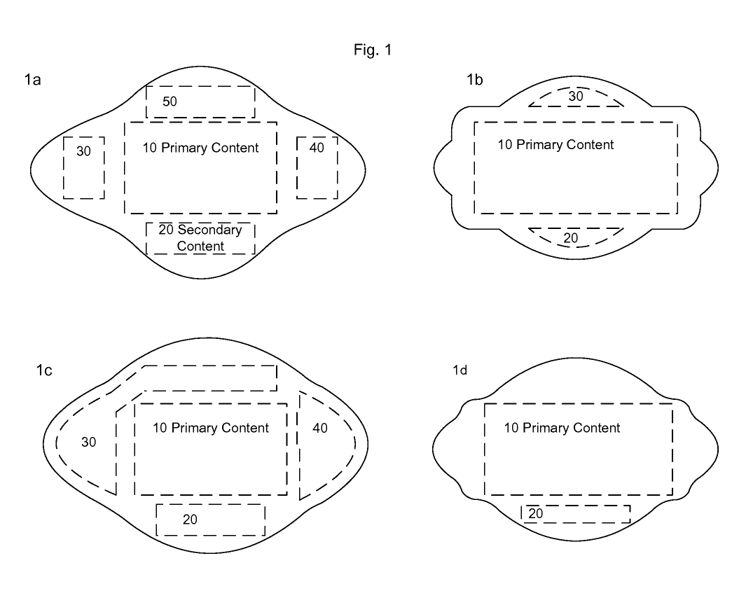

FIG. 1 presents embodiments of a mobile handheld device for displaying advertisements in an unobtrusive manner alongside video content. As shown in FIG. 1, the device comprises one or more displays with the ability to present to the user one or more content regions. The device in each of these examples can be comfortably held in a user's hand while watching the content. FIGS. 1a-1d show various, non-limiting examples of the physical design of the invention. In each drawing of FIG. 1, multiple display regions can be seen where secondary content can be shown along with the primary content. For example, in FIG. 1a, primary content is shown in display region 10 while at the same time, secondary content may be displayed in content region 20. Additionally, display regions 30, 40 and 50 may display additional secondary content. FIGS. 1b-1d show alternate device shapes and configurations with different regions for secondary content.

The main content can be a movie, short video clips, a presentation, a picture slide show, a live video feed, or any other content that a user wishes to view. The optimal aspect ratio of the display region for showing primary content is 16:9, which is the international standard format of HDTV, but it can be in any aspect ratio, as long as the display region for showing the primary content is rectangular. The secondary content can be advertisements, reminders, information relating to the main content, or any other information that the content provider wishes to convey to the user. Display regions for showing secondary content are not limited to being rectangular and may be any shape, examples of which are shown in FIGS. 1b and 1c.

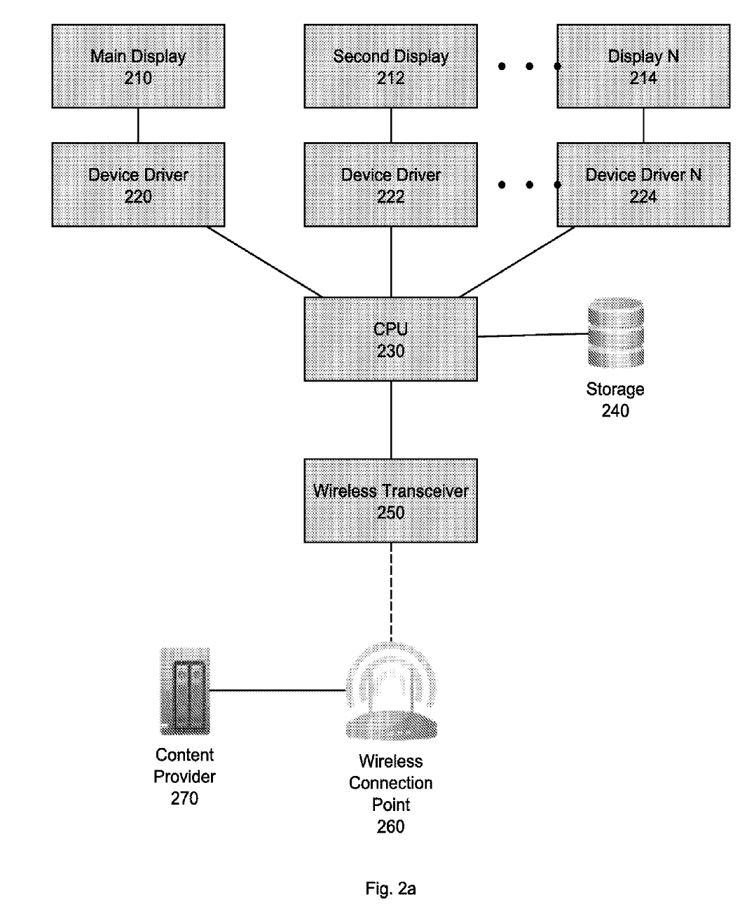

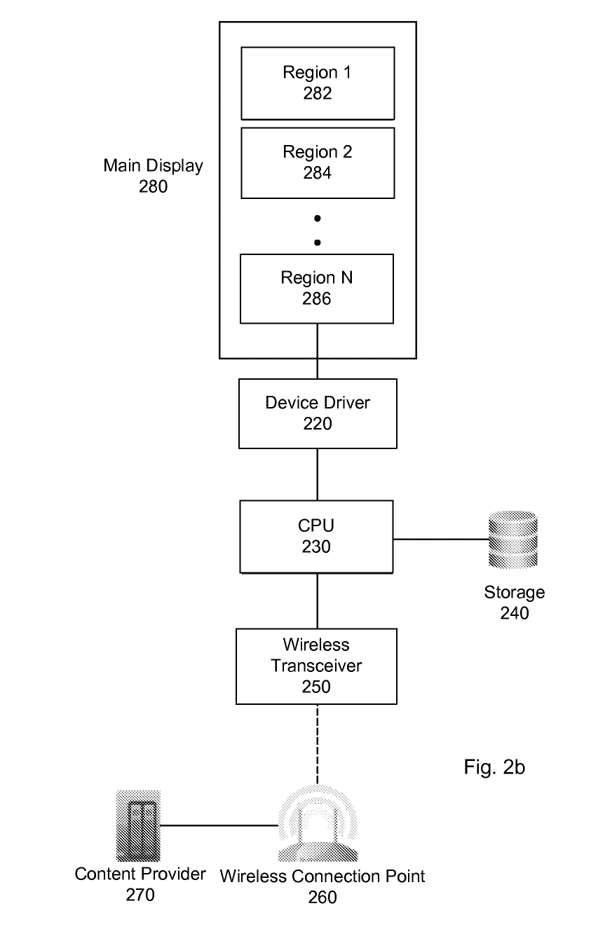

FIG. 2a is a block diagram of one embodiment of the hardware of the invention. This is only a high-level diagram and should not be used to limit the device to only these components. Main display 210 is connected to a device driver 220 that drives the display. The main display 210 presents the primary content and is rectangular in shape. Driver 220 is connected to a CPU 230 which is the main controller for the entire device. A second display 212 is connected to or integral with a second device driver 222 that drives the second display. Device Driver 222 is also connected to CPU 230. The second display 212 may be connected to or integral with driver 220 if driver 220 is capable of driving two displays at once. In this case, driver 222 would not be needed. The second display 212 presents secondary content to the user. In addition to second display 212, there may be any number of displays 214 for also presenting secondary content. These second displays may each be connected to or integral with corresponding device drivers 224—or as with second display 212, they may be connected to or integral with device driver 220, if device driver 220 is so capable. Second displays 212, 214 are not limited to being rectangular and could be any shape, as represented, for example, by elements 20 and 30 in FIG. 1b. Displays for presenting secondary content are situated outside the regular shape and region of the main display.

Attached to CPU 230 is storage 240, which can be a hard drive or solid state RAM or any other memory to store the programs needed to run the device, perhaps including an operating system and web browser. Storage 240 can also store primary and secondary content to be viewed by the user if the user is not connected to any content provider. Also attached to CPU 230 is a wireless transceiver 250 that is able to communicate wirelessly to a wireless connection point 260, such as wireless router or a cell-phone service, in order to connect to a content provider 270.

FIG. 2b is a block diagram of another embodiment of the hardware of the invention. This is only a high-level diagram and should not be used to limit the device to only these components. The basic components 220-270 may be the same as in FIG. 2a. Here, main display 280 comprises more than one display region, at least regions 282 and 284. Region 282 may display the primary content and region 284 may display secondary content. Any number of other regions 286 can also display secondary content. The regions displaying secondary content are not limited to being rectangular and could be any shape, as represented, for example, by elements 20 and 30 in FIG. 1b. Regions for presenting secondary content are situated outside the regular shape and region of region 282, which presents the primary content.

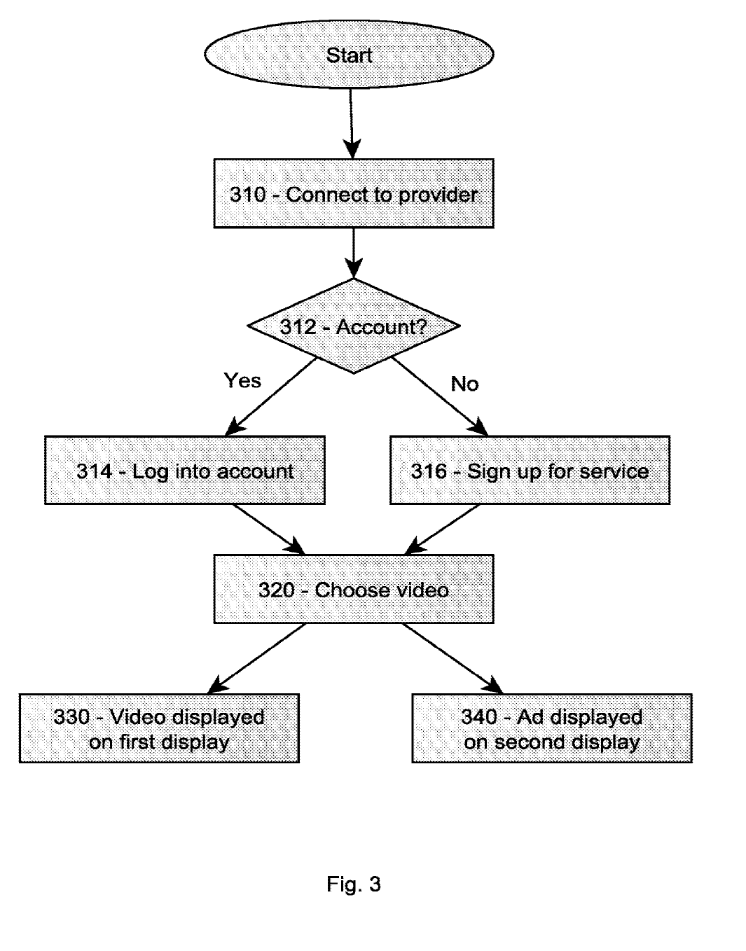

FIG. 3 is a flow chart that shows an embodiment of how content arrives at and is displayed on the device. At step 310, the user connects to a content provider. At step 312, the provider checks to see if the user has an account. If the user has an account with the provider, then the user may need to only provide a password to login to the system at step 314. If the user does not have an account, he or she may sign up for the content at step 316. At step 320, the user chooses a video or some other content to be played on the device. Alternatively, the user may have selected content at an earlier time or may be in the middle of watching certain content, in which case this content will be readied to play on the device. At step 330, the primary content is played on the first display (for example, element 210 in FIG. 2a) while at the same time secondary content may be shown on the second display (for example, element 212 in FIG. 2a) at step 340. One will recognize that other embodiments may include the content being stored in the device's memory, so that it can be watched while the device is not connected to the content provider. In this case, the secondary content may also be stored in the device's memory to be displayed alongside the main content.

Alternatively, a combination of stored content and online content may be viewed by the user. Primary content may be stored on the device while updated or alternate secondary content is fed from the content provider to the device. This keeps the advertisements current. Updates to the secondary content may also be downloaded while the user is not actively using the device, so that the updated secondary content is ready when the user views the primary content.

I claim:

1. A handheld mobile device having a visual display with multiple regions for displaying primary content and secondary content related to the primary content, comprising:
a first region of the display for displaying primary content, wherein the first region is rectangular with a standard video aspect ratio; and
one or more second regions of the display for displaying secondary content, wherein the one or more second regions are not rectangular, do not overlap with the first region and are smaller than the first region.

2. The device in claim 1 wherein at least one of the second regions is physically attached to the first region by a hinge so that it can fold over the first region when the device is not in use.

3. A method for displaying advertisements on a device comprising:
displaying primary content on a first region of a display,
displaying an advertisement on a second region of the display, wherein the first and second regions of the display are separate screens on the same device.
